(19) United States
(12) Patent Application Publication
(10) Pub. No.: US 2009/0275300 A1
(43) Pub. Date: Nov. 5, 2009

(54) Receiver and receiving method of FM signal

(75) Inventor: Chat-Chin Quek, Pingjhen City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/230,861

(22) Filed: Sep. 5, 2008

(30) Foreign Application Priority Data
Apr. 30, 2008 (TW) 097115992

(51) Int. Cl. H04B 1/18

(52) U.S. Cl. 455/192.1

(57) ABSTRACT

A receiver of a frequency modulation (FM) signal includes an antenna, a tuner, an analog-to-digital converter (ADC), a demodulation module and a frequency offset estimation module. The antenna receives a FM signal. The tuner coupled to the antenna is for converting the FM signal into an intermediate frequency signal. The ADC coupled to the tuner is for converting the intermediate frequency signal into a digital intermediate frequency signal. The demodulation module coupled to the ADC is for demodulating the digital intermediate frequency signal into an audio signal based on a frequency offset compensation signal. The frequency offset estimation module coupled to the demodulation module is for generating the frequency offset compensation signal according to the audio signal.

This application claims the benefit of Taiwan application Serial No. 97115992, filed Apr. 30, 2008, the subject matter of which is incorporated herein by reference.

### BACKGROUND OF THE INVENTION

1. Field of the Invention

The invention relates in general to a receiver and a receiving method of a FM signal, and more particularly to a receiver and a receiving method of a FM signal capable of compensating for a frequency offset.

2. Description of the Related Art

The frequency modulation technology is widely applied to the modern communication system. A transmitter performs the frequency modulation on to-be-transmitted data according to a specific wireless communication standard and thus obtains a frequency modulation (FM) signal, which is a radio frequency signal. A receiver receives the FM signal and demodulates the FM signal to reproduce the to-be-transmitted data.

FIG. 1 (Prior Art) is a block diagram showing a conventional FM signal receiver 100. Referring to FIG. 1, the FM signal receiver 100 includes an antenna 110, a tuner 120, an analog-to-digital converter (ADC) 130, a demodulation unit 140 and a compensation unit 150. The antenna 110 receives a frequency modulation signal FM. The tuner 120 includes a low noise amplifier 122, a local oscillator 124, a mixer 126 and an intermediate frequency amplifier 128. The low noise amplifier 122 is for amplifying the frequency modulation signal FM. The local oscillator 124 is for providing a local oscillation frequency LO. The mixer 126 down-samples the amplified frequency modulation signal FM into a first intermediate frequency signal IF1 according to the local oscillation frequency LO. The intermediate frequency amplifier 128 amplifies the first intermediate frequency signal IF1 into a second intermediate frequency signal IF2.

The ADC 130 converts the second intermediate frequency signal IF2 into a digital intermediate frequency signal DIF. The demodulation unit 140 demodulates the digital intermediate frequency signal DIF to obtain an audio signal AS. However, when a local oscillation frequency at the end of the transmitter is slightly different from the local oscillation frequency LO of the FM signal receiver 100, the audio signal AS may have the distortion so that the audio signal AS has a direct current (DC) offset level. Consequently, the system degrading phenomenon may occur.

In order to overcome the unnecessary DC offset level, the compensation unit 150 detects the DC offset level of the audio signal AS caused by the inconsistency between the carrier frequency and the local oscillation frequency LO, and thus generates a control signal CS. The compensation unit 150 adjusts the local oscillation frequency LO generated by by the local oscillator 124 according to the control signal CS to eliminate the DC offset level of the audio signal AS. However, the method of eliminating the DC offset level of the audio signal AS is applied to an analog end of the FM signal receiver 100. As for various application specific integrated circuits (ASICs), it is a preferred choice if the FM signal receiver 100 can compensate the audio signal AS at a digital end.

### SUMMARY OF THE INVENTION

The invention is directed to a receiver and a receiving method of a FM signal, wherein an audio signal is compensated at a digital end of the receiver to eliminate a direct current (DC) offset level of the audio signal caused by a frequency offset.

According to a first aspect of the present invention, a FM signal receiver including an antenna, a tuner, an analog-to-digital converter (ADC), a demodulation module and a frequency offset estimation module is provided. The antenna is for receiving a FM signal. The tuner coupled to the antenna is for converting the FM signal into an intermediate frequency signal. The ADC coupled to the tuner is for converting the intermediate frequency signal into a digital intermediate frequency signal. The demodulation module coupled to the ADC is for demodulating the digital intermediate frequency signal into an audio signal based on a frequency offset compensation signal. The frequency offset estimation module coupled to the demodulation module is for generating the frequency offset compensation signal according to the audio signal.

According to a second aspect of the present invention, a receiving method of a FM signal is provided. The method includes the following steps. The FM signal is received and converted into an intermediate frequency signal. The intermediate frequency signal is converted into a digital intermediate frequency signal. The digital intermediate frequency signal is demodulated into an audio signal based on a frequency offset compensation signal. The frequency offset compensation signal is generated according to the audio signal.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a block diagram showing a conventional FM signal receiver.

FIG. 2 is a block diagram showing a FM signal receiver according to a preferred embodiment of the invention.

FIG. 3 is a block diagram showing a frequency offset estimation module according to the preferred embodiment of the invention.

FIG. 4 is a flow chart showing a receiving method of a FM signal according to the preferred embodiment of the invention.

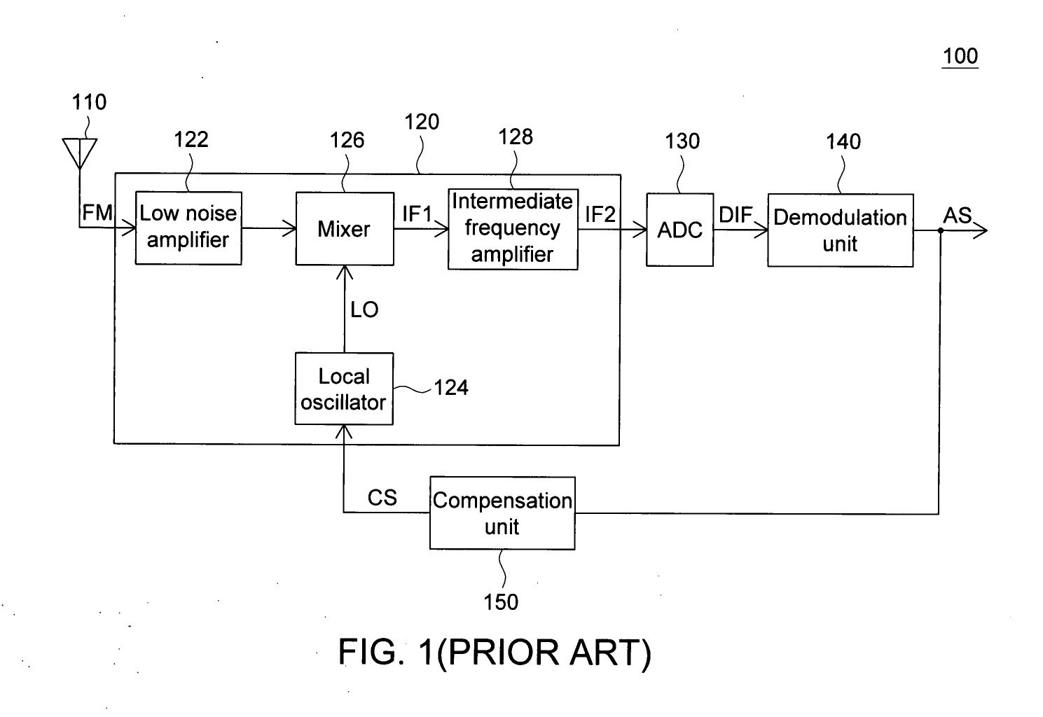

### DETAILED DESCRIPTION OF THE INVENTION

The invention provides a FM signal receiver and a receiving method for estimating a direct current (DC) offset level of an audio signal caused by a frequency offset, and compensating the audio signal at a digital end of the FM signal receiver. Thus, the DC offset level of the audio signal caused by distortion can be eliminated, and the frequency offset of the audio signal can be thus eliminated.

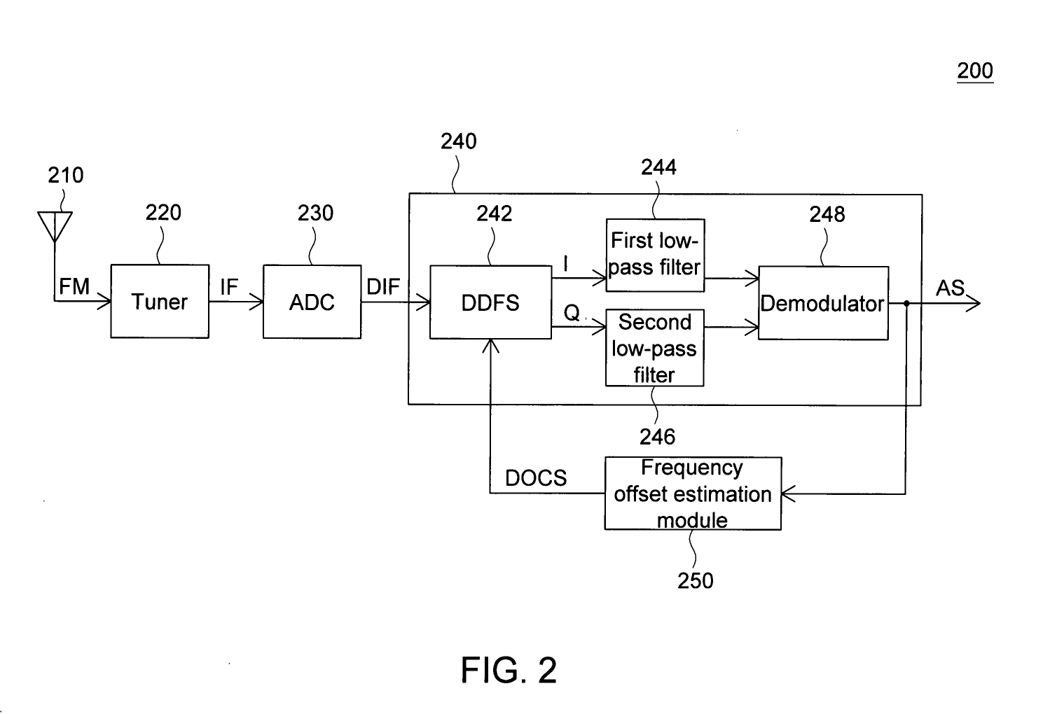

FIG. 2 is a block diagram showing a FM signal receiver 200 according to a preferred embodiment of the invention. Referring to FIG. 2, the FM signal receiver 200 includes an antenna 210, a tuner 220, an analog-to-digital converter (ADC) 230, a demodulation module 240 and a frequency offset estimation module 250. The antenna 210 is for receiving a frequency modulation signal FM, which contains pilot information for indicating, for example, pilot data of a sound mode. The tuner 220 coupled to the antenna 210 is for converting the frequency modulation signal FM into an intermediate frequency signal IF, which is a sound intermediate frequency signal, for example. The ADC 230 coupled to the tuner 220 is for converting the intermediate frequency signal IF into a digital intermediate frequency signal DIF.

The demodulation module 240 coupled to the ADC 230 is for demodulating the digital intermediate frequency signal DIF into an audio signal AS based on a frequency offset compensation signal DOCS. The demodulation module 240 includes a direct digital frequency synthesizer (DDFS) 242, a first low-pass filter 244, a second low-pass filter 246 and a demodulator 248. The DDFS 242 is coupled to the ADC 230. If a carrier frequency of the frequency modulation signal FM has a carrier offset, the frequency of the DDFS 242 is different from the carrier frequency of the frequency modulation signal FM so that the audio signal AS obtained by the demodulation of the demodulation module 240 has distortion. That is, the audio signal AS has the DC offset level caused by the frequency offset.

The distortion of the audio signal AS represents that the pilot information may be lost. Consequently, various problems may rise. For example, the frequency modulation signal FM received by the FM signal receiver 200 is a stereo signal, but the audio signal AS received by the demodulation module 240 is a mono signal. Thus, the frequency offset estimation module 250 coupled to the demodulation module 240 is for generating the frequency offset compensation signal DOCS according to the DC offset level of the audio signal AS.

The DDFS 242 eliminates the carrier offset of the frequency modulation signal FM based on the frequency offset compensation signal DOCS and converts the digital intermediate frequency signal DIF into a digital in-phase baseband signal I and a digital quadrature baseband signal Q. The first low-pass filter 244 coupled to the DDFS 242 is for filtering the digital in-phase baseband signal I. The second low-pass filter 246 coupled to the DDFS 242 is for filtering the digital quadrature baseband signal Q. The demodulator 248 coupled to the first low-pass filter 244 and the second low-pass filter 246 is for demodulating the filtered digital in-phase baseband signal I and the filtered digital quadrature baseband signal Q to obtain the audio signal AS.

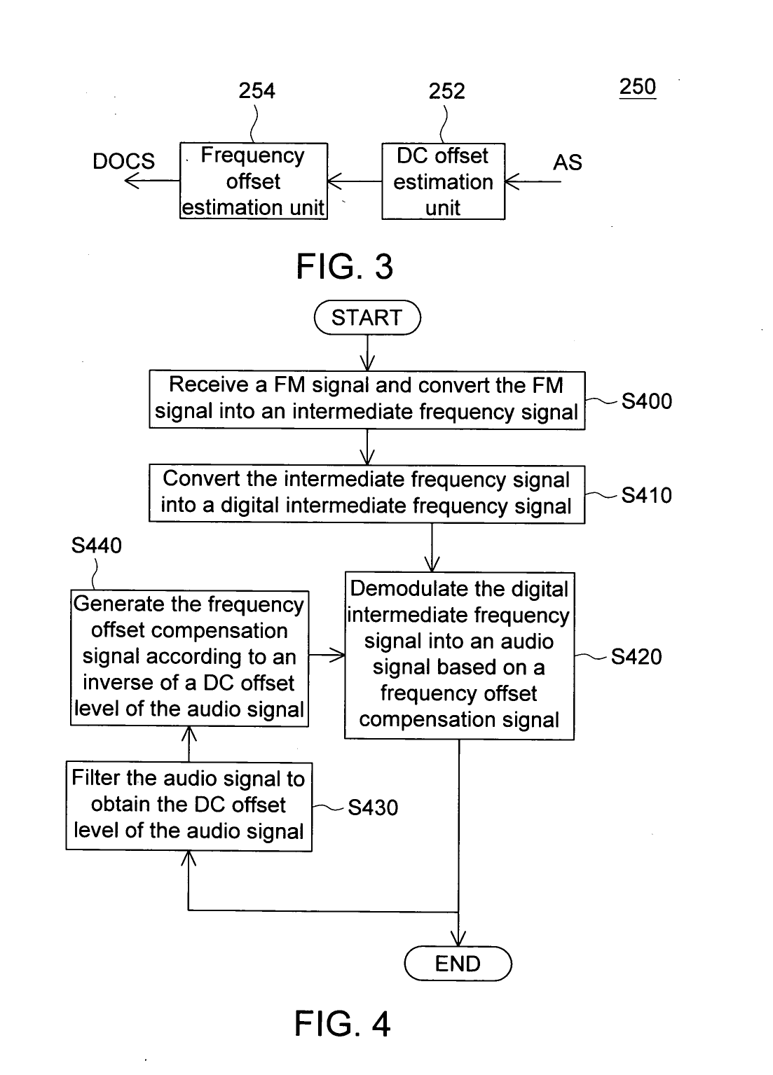

FIG. 3 is a block diagram showing a frequency offset estimation module according to the preferred embodiment of the invention. Referring to FIG. 3, the frequency offset estimation module 250 includes a DC offset estimation unit 252 and a frequency offset compensation estimation unit 254. The DC offset estimation unit 252 substantially may be regarded as a low-pass filter, such as a loop filter, for filtering the audio signal AS to filter out the high-frequency component of the audio signal AS. Consequently, the DC offset estimation unit 252 can obtain the DC offset level of the audio signal AS, wherein the DC offset level corresponds to the carrier offset of the frequency modulation signal FM, such as 0.5 volts. The frequency offset compensation estimation unit 254 coupled to the DC offset estimation unit 252 then converts an inverse of the DC offset level of the audio signal AS, such as −0.5 volts, into a compensation frequency to generate the frequency offset compensation signal DOCS. The DDFS 242 can eliminate the carrier offset of the frequency modulation signal FM based on the frequency offset compensation signal DOCS.

FIG. 4 is a flow chart showing a receiving method of a FM signal according to the preferred embodiment of the invention. First, in step S400, a FM signal is received and converted into an intermediate frequency signal. Next, in step S410, the intermediate frequency signal is converted into a digital intermediate frequency signal. Then, in step S420, the digital intermediate frequency signal is demodulated into an audio signal based on a frequency offset compensation signal. Meanwhile, the audio signal is filtered to obtain the DC offset level of the audio signal in step S430. Thereafter, in step S440, the frequency offset compensation signal is generated according to an inverse of the DC offset level of the audio signal. The details of the receiving method of the FM signal have been described in the FM signal receiver 200, so detailed descriptions thereof will be omitted.

In the FM signal receiver and the receiving method according to the embodiment of the invention, the DC offset level of the audio signal caused by the frequency offset is estimated, and the DDFS of the FM signal receiver then converts the inverse of the estimated DC offset level into the compensation frequency to generate the frequency offset compensation signal to compensate the audio signal so as to eliminate the carrier offset of the FM signal. Consequently, the audio signal can be compensated at the digital end of the FM signal receiver. So, compared with the prior art, the FM signal receiver and the receiving method of the invention are more suitable for the modern popular ASIC, and the eliminated carrier offset of the FM signal may reach 150 KHz.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A frequency modulation (FM) signal receiver, comprising:
an antenna for receiving a FM signal;
a tuner, coupled to the antenna, for converting the FM signal into an intermediate frequency signal;
an analog-to-digital converter (ADC), coupled to the tuner, for converting the intermediate frequency signal into a digital intermediate frequency signal;
a demodulation module, coupled to the ADC, for demodulating the digital intermediate frequency signal into an audio signal based on a frequency offset compensation signal; and
a frequency offset estimation module, coupled to the demodulation module, for generating the frequency offset compensation signal according to the audio signal.

2. The receiver according to claim 1, wherein the frequency offset estimation module comprises:
a direct current (DC) offset estimation unit for obtaining a DC offset level of the audio signal; and
a frequency offset compensation estimation unit, coupled to the DC offset estimation unit, for generating the frequency offset compensation signal according to an inverse of the DC offset level of the audio signal.

3. The receiver according to claim 2, wherein the DC offset estimation unit is a low-pass filter for filtering the audio signal to obtain the DC offset level of the audio signal.

4. The receiver according to claim 1, wherein the demodulation module comprises:
a direct digital frequency synthesizer (DDFS), coupled to the ADC, for converting the digital intermediate frequency signal into a digital in-phase baseband signal and a digital quadrature baseband signal based on the frequency offset compensation signal;
a first low-pass filter, coupled to the DDFS, for filtering the digital in-phase baseband signal;
a second low-pass filter, coupled to the DDFS, for filtering the digital quadrature baseband signal; and
a demodulator, coupled to the first low-pass filter and the second low-pass filter, for demodulating the filtered digital in-phase baseband signal and the filtered digital quadrature baseband signal to obtain the audio signal.

5. The receiver according to claim 1, wherein the intermediate frequency signal is a sound intermediate frequency signal.

6. A receiving method of a frequency modulation (FM) signal, the method comprising the steps of:
(a) receiving the FM signal and converting the FM signal into an intermediate frequency signal;
(b) converting the intermediate frequency signal into a digital intermediate frequency signal; and
(c) demodulating the digital intermediate frequency signal into an audio signal based on a frequency offset compensation signal,
wherein the frequency offset compensation signal is generated according to the audio signal.

7. The method according to claim 6, further comprising the steps of:
(d) filtering the audio signal to obtain a direct current (DC) offset level of the audio signal; and
(e) generating the frequency offset compensation signal according to an inverse of the DC offset level of the audio signal.

8. The method according to claim 6, wherein the step (c) comprises:
(c1) converting the digital intermediate frequency signal into a digital in-phase baseband signal and a digital quadrature baseband signal based on the frequency offset compensation signal;
(c2) filtering the digital in-phase baseband signal and the digital quadrature baseband signal; and
(c3) demodulating the filtered digital in-phase baseband signal and the filtered digital quadrature baseband signal to obtain the audio signal.

9. The method according to claim 6, wherein the intermediate frequency signal is a sound intermediate frequency signal.
